(19) United States
(12) Patent Application Publication
(10) Pub. No.: US 2010/0010832 A1
(43) Pub. Date: Jan. 14, 2010

(54) System and Method for The Diagnosis and Alert of A Medical Condition Initiated By Patient Symptoms

(76) Inventors: Willem Boute, Brummen (NL); David Robert Hampton, Woodinville, WA (US); Wilbert Wesselink, Doesburg (NL); Bernardus Anthony Albers, Warnsveld (NL)

Correspondence Address: MEDTRONIC, INC., 710 MEDTRONIC PARKWAY NE, MINNEAPOLIS, MN, 55432-9924, US

(21) Appl. No.: 12/170,313

(22) Filed: Jul. 9, 2008

(51) Int. Cl. G06Q 50/00

(52) U.S. Cl. 705/3

(57) ABSTRACT

A system and method are provided for diagnosing and generating an alert for a medical condition using procedures initiated by symptoms being experienced by a patient. Diagnostic procedures are initiated in response to the patient entering specific symptoms the patient is experiencing through a patient activator device. The patient activator device may then acquire more information related to the symptoms from the patient, instruct an implantable medical device to perform measurements of certain physiological parameters related to the symptoms, or instruct the patient to perform certain tests. The symptoms and data collected from the patient and medical device are transmitted to a remote diagnostic device for performing clinical decisions based on such information and determining whether the patient is experiencing a particular medical condition. Upon detection of a condition, the remote diagnostic device generates an automated response that may include generating alerts to patients/physicians or instructions for treatment.

### TECHNICAL FIELD

This disclosure relates generally to medical devices and more particularly to a system and method for diagnosing and generating an alert for a medical condition based using procedures initiated by patient symptoms.

### BACKGROUND

Historically, in a home monitoring setting in which an implantable, subcutaneous or external medical device is used to monitor physiological parameters in a patient, various physiological parameters have been monitored to ensure that they fall within certain acceptable values or ranges. When the monitored physiological parameters or vital signs of the patient exceed a certain threshold or fall outside of the acceptable range, alerts are generated to notify the patient or a physician of this occurrence. However, in specific cases, patient symptoms may occur before a vital sign or physiological parameter falls outside of the acceptable range, where generating the alert only after the vital sign or physiological parameter falls out of the acceptable range can lead to the late recognition of a medical condition in a patient.

### SUMMARY

A system and method are provided for diagnosing and generating an alert for a medical condition using procedures initiated by symptoms being experienced by a patient. In one or more embodiments, the method involves having a patient initiate diagnostic procedures or to record associated data which documents the physiologic states associated with symptom occurrence or onset in an implantable, subcutaneous or external medical device at a point in time when the patient is experiencing or begins experiencing certain symptoms. The diagnostic procedures are initiated in response to the patient entering the specific symptoms the patient is experiencing through an interface on a patient activator device. In one or more embodiments, the patient activator device may then acquire more information related to the symptoms by querying the patient with additional symptom-related questions or by providing the patient with the ability to enter additional information related to the symptoms. In one or more embodiments, the patient activator device may communicate with the medical device to instruct the medical device to perform measurements, to make comparisons to baseline data collected automatically when the patient was asymptomatic, to calculate trends associated with the onset of the symptomatic state, or to perform detailed analysis of certain physiological parameters related to the symptoms. In one or more embodiments, the patient activator device may instruct the patient to perform certain supplemental actions, tests or measurements (e.g., of additional physiological parameters) and to specify the results of those actions, test or measurements. These results may additionally be compared with values, changes, or trends in associated physiologic parameters additionally collected by the medical device.

In one or more embodiments, the method then communicates the various types of information and data collected from the patient and the medical device to a remote location for review and analysis. The patient activator device itself may be capable of transmitting the information to the remote location or alternatively the patient activator device and/or medical device may communicate the collected information to a transceiver in the patient's home that is capable of transmitting the information to the remote location. In one or more embodiments, the remote location may include a server having a software program running thereon for performing clinical decisions based on the symptoms and other information received to detect whether the patient is experiencing a medical condition. In some embodiments, the symptoms and other information can be alternatively be transmitted to a physician, clinician or call center for review. Once a determination has been made at the remote location that the patient is experiencing a particular medical condition, a number of possible responses can be initiated, including i) generating an alert to the patient, ii) generating an alert to medical personnel (e.g., a physician, hospital or emergency response (ER) team) or non-medical personnel (e.g., a family member or neighbor), iii) generating instructions to the patient, a physician, a clinician or an ER individual to take certain actions for treating the diagnosed condition, iv) providing instructions for collecting additional physiological parameter data, and/or v) causing certain therapies to be delivered to the patient. By allowing patient symptoms as a first sign of an impending event or condition to trigger a home monitoring system to diagnose the condition and increasing the ‘alert state’ of the system, the time to therapy and treatment can be shortened which in many cases will improve the outcome for the patient.

The system for diagnosing and generating an alert for a medical condition using procedures initiated by symptoms being experienced by a patient includes a patient activator device having an interface that allows symptoms being experienced by the patient to be entered. In one or more embodiments, the patient activator device may comprise a mobile telephone, an in-home monitoring device, a personal computer, a handheld or wearable device, or any device capable of receiving an input from the patient, communicating a response to the patient, and communicating with other components of the system. Upon receiving patient symptoms, the system collects additional information useful in diagnosing a medical condition related to the entered symptoms. In one or more embodiments, the system instructs an implantable, subcutaneous or external medical device to perform measurements of certain physiological parameters of the patient related to the symptoms. The medical device may include one or more physiological sensors arranged with respect to the patient so as to measure physiological signals for use in deriving certain physiological parameters that are useful in diagnosing the medical condition. In one or more embodiments, the patient activator device may, via a patient interface, instruct the patient to enter additional information related to the symptoms or perform certain actions, tests or measurements (e.g., of additional physiological parameters) and to provide the results of those actions, test or measurements.

The system includes a transceiver arranged for receiving the entered symptoms and additional information collected from the patient, the medical device, and the additional tests or measurements. The transceiver may be included within the patient activator device itself or may alternatively be included within a separate device in communication with the system components. The transceiver communicates the collected information to a remote diagnostic device at a remote location for diagnostic analysis. In one or more embodiments, the remote diagnostic device may include a server having a software program running thereon for performing clinical decisions based on the symptoms and other information received. In some embodiments, the patient activator device itself may include a software program running thereon for performing the clinical decisions based on the symptoms and other information collected. In some embodiments, the symptoms and other information collected can be alternatively be transmitted to a physician, clinician or call center for review. The remote diagnostic device includes processing modules or circuitry for determining whether the patient is experiencing a particular medical condition. Once it is determined that the patient is likely to experiencing a certain medical condition, the remote location further includes components for generating alerts to or communicating with various individuals (e.g., the patient or physician) and to various locations who may further interpret the information and, if needed, respond to the patient's condition with consultation and/or intervention. The remote diagnostic device may further include components for generating and delivering instructions to the patient, a physician, a clinician or an ER team to take certain actions for treating the diagnosed condition. This set of responders may include both medical personnel (e.g.: EMS, physician on call) and non-medical personnel (e.g.: designated responders such as family members or neighbors). In some circumstances, the diagnosed condition may require further diagnosis (e.g.: collection of a 12-lead ECG) prior to the delivery of the appropriate treatment. The remote diagnostic device may further include components for providing instructions to the patient or the medical device to collect additional physiological parameter data and/or cause certain therapies to be delivered to the patient. In some embodiments, if a patient fails to respond to or stops responding to such instructions, alerts may be generated to automatically notify certain caregivers.

### DRAWINGS

The above-mentioned features and objects of the present disclosure will become more apparent with reference to the following description taken in conjunction with the accompanying drawings wherein like reference numerals denote like elements and in which:

FIG. 1 is a block diagram illustrating the various components of the system for diagnosing a medical condition and generating an alert for the diagnosed medical condition using procedures initiated by symptoms in accordance with one or more embodiments of the present disclosure.

FIG. 2 is a block diagram illustrating the various components of the system for diagnosing a medical condition and generating an alert for the diagnosed medical condition using procedures initiated by symptoms in accordance with one or more embodiments of the present disclosure.

FIG. 3 is an operational flow diagram illustrating a process for diagnosing a medical condition and generating an automated response for the diagnosed medical condition using procedures initiated by symptoms in accordance with one or more embodiments of the present disclosure.

FIG. 4 is an operational flow diagram illustrating a process for diagnosing a medical condition and generating an automated response for the diagnosed medical condition using procedures initiated by symptoms in accordance with one or more embodiments of the present disclosure.

FIG. 5 illustrates components of the system including an implantable medical device in accordance with one or more embodiment of the present disclosure.

FIG. 6 is a block diagram illustrating the various system components at the patient site configured to operate in accordance with one or more embodiments of the present disclosure.

FIG. 7 is a block diagram illustrating the various components of the remote diagnostic device configured to operate in accordance with one or more embodiments of the present disclosure.

### DETAILED DESCRIPTION

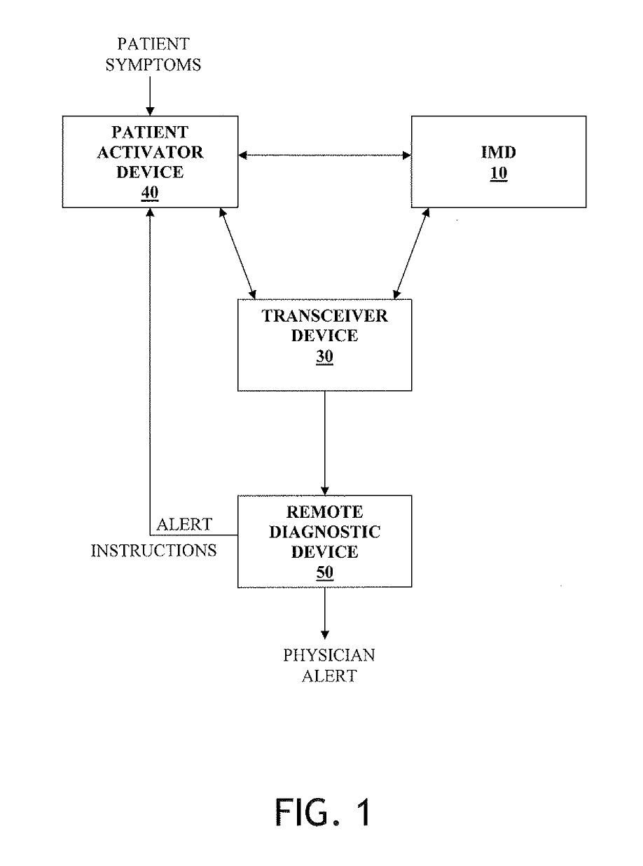

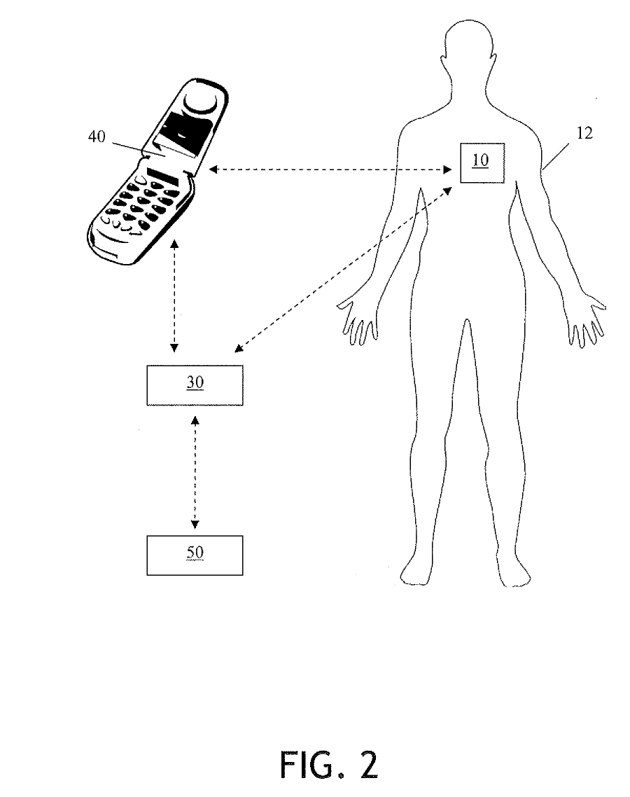

A system and method are provided for diagnosing a medical condition and generating an alert for the diagnosed medical condition using procedures initiated by symptoms being experienced by a patient. In one or more embodiments, the system includes an implantable medical device (IMD) 10, a patient activator device 40, a transceiver device 30, and a remote diagnostic device 50, as illustrated in the block schematic illustration of FIG. 1. Patient activator device 40 includes an interface that allows symptoms being experienced by the patient to be entered or input into patient activator device 40 and for a response to be communicated to the patient 12 via the same patient activator device 40 or a separate associated device. In one or more embodiments, patient activator device 40 may comprise a mobile telephone that communicates wirelessly with IMD 10 implanted within a patient 12, as illustrated in FIG. 2. In some embodiments, patient activator device 40 may comprise an in-home monitoring device, a personal computer, a handheld or wearable device, or any other device capable of receiving an input from the patient 12 and communicating with other components of the system. The patient 12 or another individual having access to the patient activator device 40 can then input certain symptoms into the patient activator device 40 or otherwise provide an indication that the patient 12 is experiencing certain symptoms. Further, patient activator device 40 may be portable, carryable, wearable or located within the patient's home to allow the patient 12 to input symptoms at the first sign of such symptoms no matter where the patient 12 may be located when such symptoms occur.

In one or more embodiments, patient activator device 40 is configured to then initiate certain diagnostic procedures to detect whether the patient 12 is experiencing a certain medical condition in response to the input patient symptoms. In some embodiments, patient activator device 40 is configured to initiated the recording of associated data which documents the physiologic states associated with symptom occurrence or onset in response to the input patient symptoms. Conventionally, patients have been forced to make an appointment with a physician to investigate symptoms the patients may be experiencing. Further, patients will often wait to seek medical assistance until their symptoms become severe, which conventionally has also led to late detection of medical conditions. In the present system and method, by allowing patient symptoms as a first sign of an impending event or condition to trigger diagnostic procedures (e.g., through a home monitoring system) to diagnose a medical condition, a medical condition may potentially be diagnosed to be occurring in a patient at an early stage, thereby shortening the time to therapy and treatment and in many cases improving the outcome for the patient.

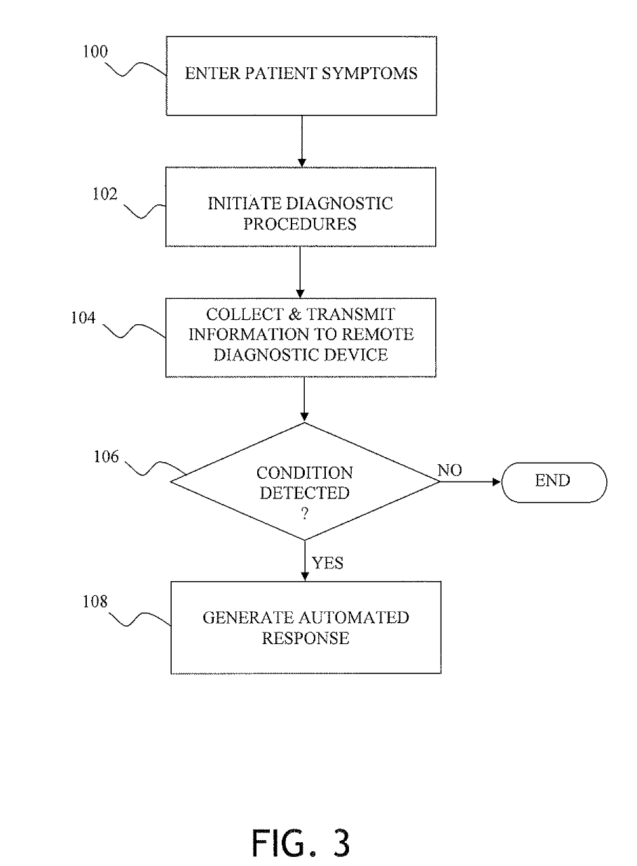

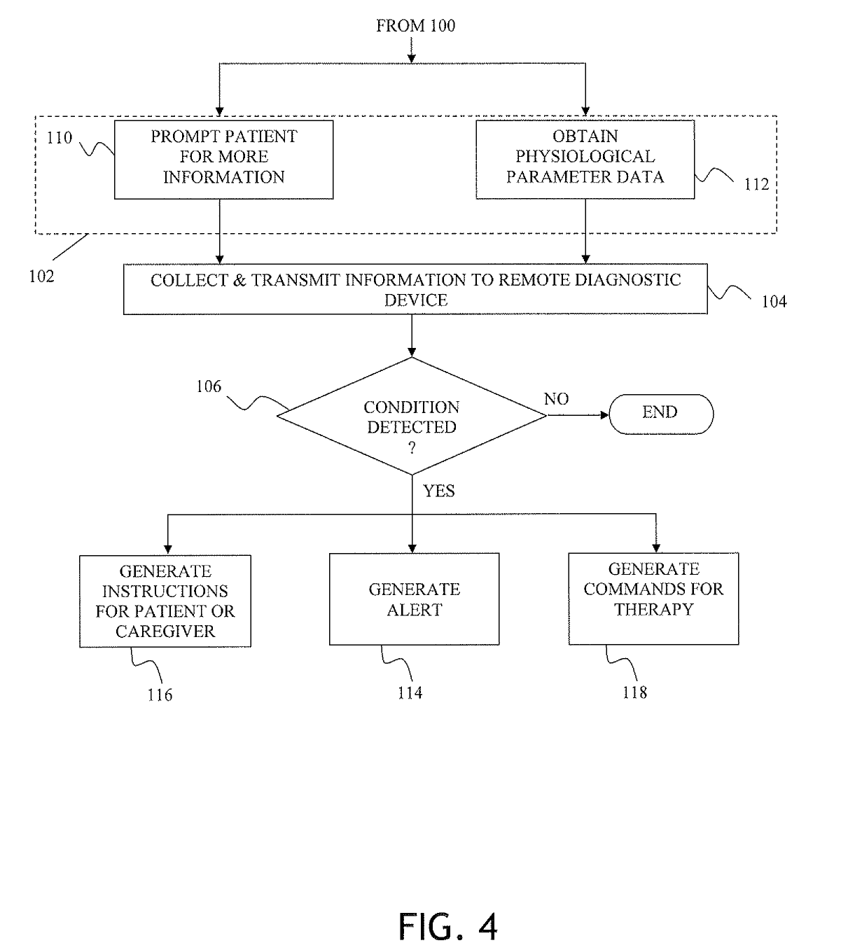

With further reference to FIG. 3, an operation flow diagram is provided for one or more embodiments of a method of diagnosing a medical condition and generating an alert for the diagnosed medical condition using procedures initiated by symptoms being experienced by a patient. Initially, in step 100 patient symptoms are entered into patient activator device 40, which is configured to initiate certain diagnostic procedures in step 102 upon receiving patient symptoms. The diagnostic procedures will collect additional information related to the input symptoms that will be useful in diagnosing or documenting a medical condition related to the input symptoms. In one or more embodiments, the diagnostic procedures implemented by patient activator device 40 in step 102 may involve querying the patient 12 for additional information, as further illustrated as step 110 in FIG. 4. The patient 12 or another individual may be provided with an opportunity to input additional details regarding the symptoms (e.g., how long the symptoms have been present, the location of the symptoms, the severity of the symptoms, environmental circumstances, the activity of the patient 12, etc.). Patient activator device 40 may also prompt specific symptom-related questions to be answered by the patient 12.

In one or more embodiments, the diagnostic procedures implemented by patient activator device 40 in step 102 may include transmitting instructions to IMD 10 in communication with patient activator device 40 to instruct IMD 10 to perform measurements of certain physiological parameters related to the symptoms, as further illustrated as step 112 in FIG. 4. In one or more embodiments, the diagnostic procedures implemented by IMD 10 may include comparisons to baseline data collected automatically when the patient was asymptomatic, calculations of trends associated with the onset of the symptomatic state, or detailed analysis of certain physiological parameters related to the symptoms. In one or more embodiments, patient activator device 40 may instruct the patient 12 or another individual to perform certain actions, tests or measurements (e.g., measuring additional physiological parameters such as blood pressure, body temperature, body weight, blood glucose levels, etc.) and to input the results of those actions, test or measurements into patient activator device 40 or another device. These results may additionally be compared with values, changes, or trends in associated physiologic parameters additionally collected by IMD 10.

In one or more embodiments, the various types of information and data collected from the patient are collected in step 104 and transmitted to a remote diagnostic device 50 at a remote location for analysis or may be analyzed in real time by IMD 10. In some embodiments, patient activator device 40 may itself be capable of transmitting the information to remote diagnostic device 50 through wireless or wired connections. In one or more embodiments, patient activator device 40 and/or IMD 10 may communicate the collected information to a transceiver device 30 in the patient's home that is capable of transmitting the information to remote diagnostic device 50.

In one or more embodiments, transceiver device 30 may be included within patient activator device 40. In one or more embodiments, transceiver device 30 may include a portable device wearable or capable of being carried by the patient. In one or more embodiments, transceiver device 30 may comprise an in-home monitoring device, such as the Medtronic CareLink® Network monitor, that collects information from IMDs implanted in patients and communicates such information to remote clinicians through the Internet, phone lines or wireless networks. Carelink is a registered trademark of Medtronic, Inc. of Minneapolis, Minn. In one or more embodiments, transceiver device 30 may be included within a personal computer or mobile phone having a software program installed thereon configured for receiving data from IMD 10, processing such data and/or further communicating such data to a remote location or clinician for further analysis and/or processing.

In one or more embodiments, remote diagnostic device 50 includes a personal computer, server computer or other computing device having a clinical decision software module installed and running thereon for performing clinical decisions based on the symptoms and other information that has been collected and transmitted to remote diagnostic device 50. In some embodiments, the symptoms and other information can be alternatively be transmitted to a physician, clinician or call center for review. The clinical decision software module operating on remote diagnostic device 50 analyzes the received information and data in step 106 to determine whether the patient 12 is experiencing a certain medical condition. Once a determination has been made that the patient is experiencing a particular medical condition, remote diagnostic device 50 generates at least one of a plurality of possible automated responses. In some embodiments, patient activator device 40 itself may include the clinical decision software module installed and running thereon for performing the clinical decisions based on the symptoms and other information that has been collected.

In one or more embodiments, the possible automated responses include generating an alert to the patient, medical personnel (e.g., a physician, hospital or emergency response (ER) team), or non-medical personnel (e.g., designated responders such as family members or neighbors) in step 114. In some embodiments, the possible automated responses include generating instructions and/or communications to the patient, a physician, a clinician, caregiver or an ER individual to take certain actions for treating the diagnosed condition in step 116. For example, the patient can be alerted of the diagnosed medical condition and notified with instructions to take certain therapeutic actions (e.g., taking aspirin, nitrates, fluids, diuretics, etc.). Still further, the instructions can instruct the patient, emergency response personnel and/or bystanders to take appropriate actions to treat the detected condition, where such instructions could be part of a bi-directional communication that occurs with paramedics/physicians that were alerted of the detected condition. In some embodiments, the possible automated responses include providing instructions for collecting additional physiological parameter data, where this additional information can be used to further diagnose additional aspects of the medical condition. In some embodiments, the possible automated responses include causing certain therapies to be delivered to the patient in step 118. For example, instructions or commands be communicated from remote diagnostic device 50 to IMD 10 to cause IMD 10 deliver certain therapy to the patient 12. In some embodiments, the instructions to the patient or caregiver may call for further diagnosis (e.g., collection of a 12-lead ECG) for use in determining the appropriate treatment to be delivered to the patient. In one or more embodiments, if a patient fails to respond, is substantially delayed in responding, or stops responding to instructions, commands or communications, alerts may be generated to automatically notify certain caregivers (e.g., EMS).

IMD 10 is described in various embodiments as comprising an implantable medical device that is implantable within the patient 12 including sensing capabilities for monitoring physiological conditions and may include alert and therapy delivery capabilities. An IMD in which the invention is implemented may be primarily intended for detecting any type of medical condition. For example, the IMD 10 may comprise any type of implanted device or subcutaneous device including, but not limited to cardiac pacemakers, implantable cardioverter-defibrillators (ICDs), implantable combination pacemaker-cardioverter-defibrillator (PCDs), implantable brain stimulators, implantable gastric system stimulators, implantable nerve stimulators or muscle stimulators, implantable lower colon stimulators, implantable drug or beneficial agent dispensers or pumps, implantable cardiac signal loops or other types of recorders or monitors, implantable gene therapy delivery devices, implantable incontinence prevention or monitoring devices, implantable insulin pumps or monitoring devices, and so on.

A wide variety of IMDs have been developed in order to monitor patient conditions and deliver therapy to the patient. An IMD typically includes a hermetically sealed housing coupled to one or more leads that are surgically implanted inside a patient for sensing conditions or for administering therapy. The IMD may provide therapeutic stimulation to the patient or may deliver drugs or agents to the patient. Alternatively or additionally, the IMD may have sensing or monitoring capabilities. For example, the IMD may sense information within a patient and store the sensed information for subsequent analysis. In some cases, the sensed information may be used directly by the IMD to adjust or control the therapy that is delivered to the patent. Telemetry is used to communicate sensed information from the IMD to an external medical device so that analysis of the sensed information can be performed. Telemetry is further used to communicate information or instructions from external medical devices to the IMD.

The invention may also be implemented in external medical devices that may be used for monitoring of a patient for detecting conditions at a variety of physical locations, such as a patient's home, a physician's office, a hospital or a treating emergency technician.

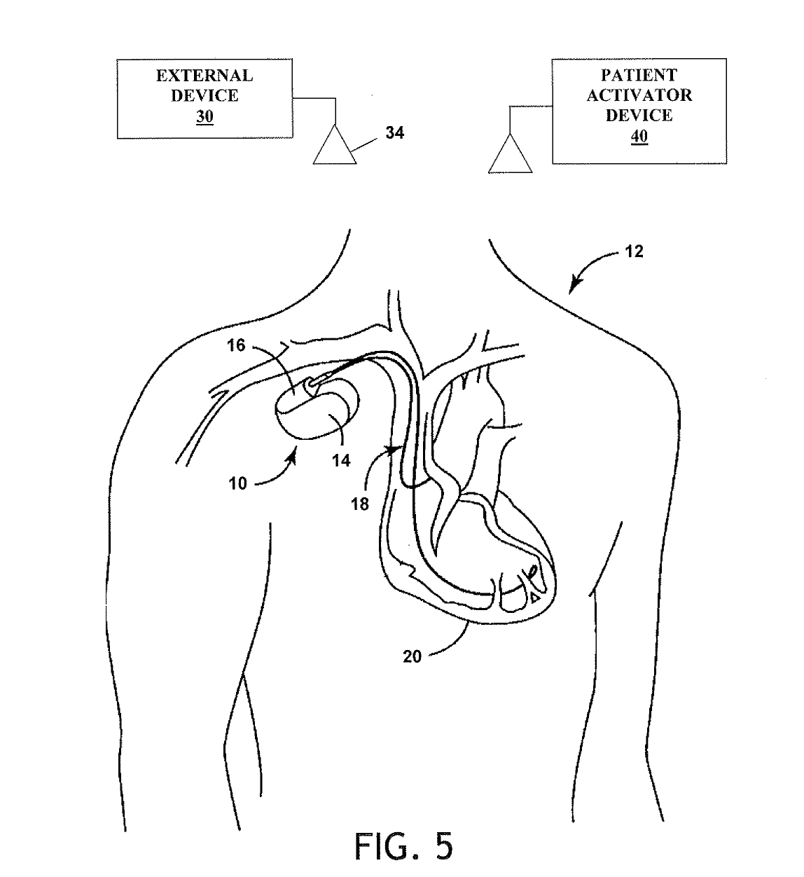

FIG. 5 is a simplified schematic view of one type of implantable medical device (“IMD”) 10 implanted within a human body 12 in which one or more embodiments may be implemented. IMD 10 comprises a hermetically sealed enclosure 14 and connector module 16 for coupling IMD 10 to electrical leads and other physiological sensors arranged within body 12, such as pacing and sensing leads 18 connected to portions of a heart 20 for delivery of pacing pulses to a patient's heart 20 and sensing of heart 20 conditions. While IMD 10 is depicted in a pacemaker device configuration in FIG. 5, it is understood that IMD 10 may comprise any type of implanted, subcutaneous or external medial device. IMD 10 collects and processes data from one or more sensors for deriving parameters used in computing a probability that a medical condition is occurring in the patient 12 in which IMD 10 is implanted. Patient activator device 40 and/or external device 30 are capable of being arranged with respect to IMD 10 such that the various components are capable of communicating with each other.

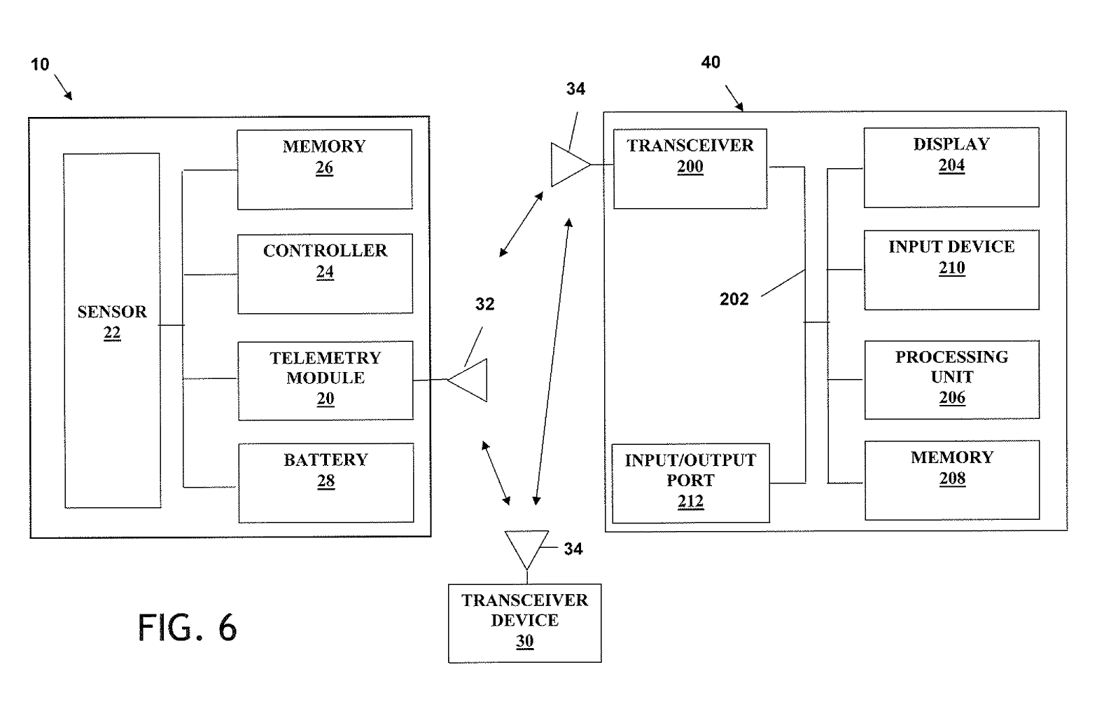

FIG. 6 is a block diagram illustrating the constituent components of IMD 10 in accordance with one or more embodiments having a microprocessor-based architecture. IMD 10 is shown as including telemetry module 20, at least one sensor 22 for sensing physiological signals, processor or controller 24, memory 26, battery 28 and other components as appropriate to produce the desired functionalities of the device.

Controller 24 may be implemented with any type of microprocessor, digital signal processor, application specific integrated circuit (ASIC), field programmable gate array (FPGA) or other integrated or discrete logic circuitry programmed or otherwise configured to provide functionality as described herein. Controller 24 executes instructions stored in memory 26 to provide functionality as described herein. Instructions provided to controller 24 may be executed in any manner, using any data structures, architecture, programming language and/or other techniques. Memory 26 is any storage medium capable of maintaining digital data and instructions provided to controller 24 such as a static or dynamic random access memory (RAM), read-only memory (ROM), non-volatile random access memory (NVRAM), electrically erasable programmable read-only memory (EEPROM), flash memory, or any other electronic, magnetic, optical or other storage medium.

In operation, IMD 10 obtains data from physiological signals via electrodes and/or sensors 22 deployed on leads 18 and/or other sources. This data is provided to controller 24, which suitably analyzes the data, stores appropriate data in memory 26, and/or provides a response or report as appropriate. Communication between IMD 10 and another device can occur via telemetry, such as a long-distance telemetry system through the telemetry module 20. Telemetry module 20 may comprise any unit capable of facilitating wireless data transfer between IMD 10 and a patient activator device 40 and/or transceiver device 30, where patient activator device 40 and/or transceiver device 30 may comprise an external medical device, a programming device, a remote telemetry station, a physician-activated device, a patient-activated device, a mobile handheld unit (e.g., mobile phone, PDA, etc.), a personal computer, an in-home monitoring device, a patient-wearable device, a display device or any other type of device capable of sending and receiving signals to and from IMD 10. Telemetry module 20 and patient activator device 40 and/or transceiver device 30 are respectively coupled to antennas 32 and 34 for facilitating the wireless data transfer. Telemetry module 20 may be configured to perform any type of wireless communication. For example, telemetry module 20 may send and receive radio frequency (RF) signals, infrared (IR) frequency signals, or other electromagnetic signals. In the case of electromagnetic signals, antennas 32 and 34 may comprise coils for transmitting and receiving signals when positioned adjacent to one another. Any of a variety of modulation techniques may be used to modulate data on a respective electromagnetic carrier wave. Alternatively, telemetry module 20 may use sound waves for communicating data, or may use the patient's tissue as the transmission medium for communicating with a programmer positioned on the patients skin. In any event, telemetry module 20 facilitates wireless data transfer between IMD 10 and patient activator device 40 and/or transceiver device 30. Other types of wired communications may also occur when IMD 10 is alternatively configured as an external medical device or contains wired communication channels that extend from within the patient to points outside of the patient.

IMD 10 includes at least one sensor 22 configured to sense at least one physiological signal or condition, from which a physiological parameter can be determined. Sensors 22 can monitor electrical, mechanical, chemical, or optical information that contains physiological data of the patient and can utilize any source of physiological signals used for physiological events or conditions. For example, sensor 22 may comprise a heart sensor, such as the MDT Reveal® system, commercially available from Medtronic of Minneapolis, that is capable of sensing cardiac activity, electrocardiograms, heart rate, or the like. Reveal is a registered trademark of Medtronic, Inc. of Minneapolis, Minn.

With further reference to FIG. 6, patient activator device 40 includes an antenna 34, coil or wired input for communicating data and other signals between patient activator device 40 and IMD 10. Data is received from IMD 10 through antenna 34, which is connected to transceiver 200 that serves to receive and transmit communication signals through antenna 34. The demodulated signals are applied in parallel or serial digital format to input/output (I/O) unit or bus 202, where they in turn may be applied to a display or screen 204, provided to processing unit 206 and/or memory 208. In some embodiments, display 204 may include other types of interface devices capable of communicating information to the patient (e.g., a speaker device or other output device). Processing unit 206 includes any type of microprocessor, digital signal processor, application specific integrated circuit (ASIC), field programmable gate array (FPGA) or other integrated or discrete logic circuitry programmed or otherwise configured to control operating of patient activator device 40 and provide functionality as described herein. In one or more embodiments, processing unit 206 executes instructions stored in memory 208 to provide functionality as described herein. In one or more embodiments, instructions may be stored in memory 208 for operating a patient symptom activator program that allows the patient to enter symptoms the patient is experiencing and may further initiate diagnostic procedures to be performed.

In one or more embodiments, patient activator device 40 includes an input device 210 that allows data, commands or selections to be input into patient activator device 40 by a patient, physician or clinician. For example, the patient's symptoms can be entered through input device 210. Input device 210 may include, but is not limited to, at least one of the following: a keyboard, keypad, track ball, mouse, touch-sensitive displays, push buttons, magnetic readers, RF readers, tablets, styluses, microphones, voice recognizers, handwriting recognizers and any other device that allows a patient, physician or clinician to input data to external device. Processing unit 206 controls operation of display 204 and is responsive to commands received from input device 210. Memory 208 is suitable for storing data received from IMD 10 or other sources, input device 210, processing unit 206 or other data or commands otherwise received by patient activator device 40. Patient activator device 40 may further include an input/output port 212 for connecting patient activator device 40 to other devices, communication networks, phone lines, wireless devices, etc. When data received from IMD 10 through the telemetry uplink or the responses to the symptom-related query are to be transmitted to a remote location for further analysis, such information and data can be transmitted through input/output port 212 to a connected network or through transceiver 200 or to a wirelessly connected device. In one or more embodiments, patient activator device 40 may relate information to the patient or a clinician by sound through speakers (not shown) in addition to or instead of presenting such information on display 204.

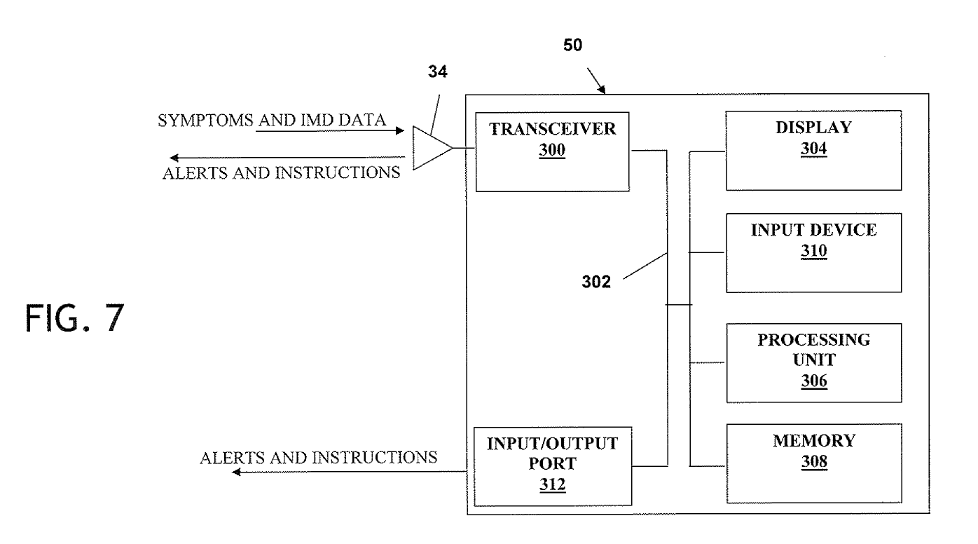

Referring now to FIG. 7, in one or more embodiments, remote diagnostic device 50 may include an antenna 34, coil or wired input for communicating data and other signals between remote diagnostic device 50 and transceiver 30 or patient activator device 40. Incoming data (i.e., patient symptoms and data collected from IMD 10) is received through antenna 34, which is connected to transceiver 300 that serves to receive and transmit communication signals through antenna 34. The demodulated signals are applied in parallel or serial digital format to input/output (I/O) unit or bus 302, where they in turn may be applied to a display or screen 304, provided to processing unit 306 and/or memory 308. Processing unit 306 includes any type of microprocessor, digital signal processor, application specific integrated circuit (ASIC), field programmable gate array (FPGA) or other integrated or discrete logic circuitry programmed or otherwise configured to control operating of remote diagnostic device 50 and provide functionality as described herein. In one or more embodiments, processing unit 306 executes instructions stored in memory 308 to provide functionality as described herein. In one or more embodiments, a instructions may be stored in memory 308 for operating the clinical decision software program for performing clinical decisions based on the symptoms and other information received by remote diagnostic device 50.

In one or more embodiments, remote diagnostic device 50 includes an input device 310 that allows data, commands or selections to be input into remote diagnostic device 50 by a patient, physician or clinician. Processing unit 306 controls operation of display 304 and is responsive to commands received from input device 310. Memory 308 is suitable for storing data received or input into remote diagnostic device 50. Remote diagnostic device 50 may further include an input/output port 312 for connecting remote diagnostic device 50 to other devices, communication networks, phone lines, wireless devices, etc. For example, automated responses (e.g., patient alerts, physician alerts, patient instructions, etc.) can be communicated through input/output port 312 or wirelessly through transceiver 300.

The system and method for diagnosing a medical condition and generating an alert for the diagnosed medical condition using procedures initiated by symptoms being experienced by a patient allow patient symptoms to trigger diagnostic procedures (e.g., through a home monitoring system) for diagnosing a medical condition. When symptoms are the first sign of an impending event or condition before vital signs and physiological parameters are outside of expected ranges or thresholds, this allows medical conditions to potentially be diagnosed to be occurring in a patient at an early stage before they would normally be detected. By utilizing automated procedures for initiating diagnostic procedures, alerts can be automatically generated that notify both the patient and the physician of a potentially diagnosed medical condition. This allows diagnosis, responses and therapies to be delivered to the patient without significant delay, thereby adding to likelihood of the effectiveness of the therapy and treatment provided to the patient. Conventionally, it has been difficult for a patient to associate such symptoms with the occurrence of a medical condition, whereas the present system and method allow the patient's symptoms to immediately trigger the diagnosis of a medical condition by triggering physiological parameters to be sensed and reported.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
receiving an indication that a patient is experiencing certain physiological symptoms through a patient activator device;
initiating a diagnostic procedure for collecting additional information useful in the diagnosis of a medical condition in response to a command received from the patient activator device prompted by the received patient symptoms;
transmitting the collected information to a diagnostic site for determining whether the patient is experiencing a certain medical condition;
generating an automated response when it is determined that the patient is experiencing the certain medical condition.

2. The method of claim 1, further comprising collecting additional information by querying the patient through the patient activator device to provide additional information related to the symptoms.

3. The method of claim 1, further comprising collecting additional information by monitoring at least one physiological signal associated with the patient and the symptoms and deriving a corresponding physiological parameter from each sensed physiological signal.

4. The method of claim 3, further comprising monitoring the at least one physiological signal in at least one of an implantable, subcutaneous and external medical device in contact with the patient.

5. The method of claim 1, further comprising operating a clinical decision program on a computing device at the diagnostic site for analyzing the collected information sent to the diagnostic site and for determining whether the patient is experiencing a certain medical condition.

6. The method of claim 1, further comprising automatically generating an alert signal from the diagnostic site upon the determination that the patient is experiencing a certain medical condition for providing a notification of the diagnosed medical condition to at least one of the patient, a physician, a designated responder, or an emergency response treatment individual.

7. The method of claim 1, further comprising automatically generating a response from the diagnostic site upon the determination that the patient is experiencing a certain medical condition for providing instructions to at least one of the patient, a physician and an emergency response treatment individual for performing certain actions for treating the diagnosed medical condition.

8. The method of claim 1, further comprising:
requiring a response from the patient; and
generating an alert to at least one of medical personnel or non-medical personnel when it is determined that the patient failed to respond to the required response.

9. A system comprising:
a patient activator device including an interface, the patient activator device configured for allowing certain physiological symptoms being experienced by a patient to be entered into the patient activator device;
a medical device configured to collect diagnostic information related to a medical condition in response to symptoms being entered into the patient activator device;
a transmission device in communication with the patient activator device and medical device for transmitting at least one of the entered symptoms and the collected diagnostic information to a diagnostic site for determining whether the patient is experiencing a certain medical condition; and
a diagnostic device at the diagnostic site for determining whether the patient is experiencing a certain medical condition and generating an automated response when a certain medical condition is diagnosed.

10. The system of claim 9, wherein the medical device includes at least one of an implantable, subcutaneous and external medical device in contact with the patient for monitoring at least one physiological signal associated with the patient and the symptoms and for deriving a corresponding physiological parameter from each sensed physiological signal.

11. The system of claim 9, wherein the patient activator device comprises medical device includes at least one of a mobile telephone, a personal computer and an in-home patient monitoring device.

12. The system of claim 9, wherein the diagnostic device includes a clinical decision program operating on a computing device at the diagnostic site for analyzing the collected information sent to the diagnostic site and for determining whether the patient is experiencing a certain medical condition.

13. The system of claim 9, wherein the diagnostic device is configured to automatically generate an alert signal from the diagnostic site upon the determination that the patient is experiencing a certain medical condition for providing a notification of the diagnosed medical condition to at least one of the patient, a physician, a designated responder, or an emergency response treatment individual.

14. The system of claim 9, wherein the diagnostic device is configured to automatically generate a response from the diagnostic site upon the determination that the patient is experiencing a certain medical condition for providing instructions to at least one of the patient, a physician and an emergency response treatment individual for performing certain actions for treating the diagnosed medical condition.

15. A system comprising:
means for receiving an indication that a patient is experiencing certain physiological symptoms through a patient activator device;
means for initiating a diagnostic procedure for collecting additional information useful in the diagnosis of a medical condition in response to a command received from the patient activator device prompted by the received patient symptoms;
means for transmitting the collected information to a diagnostic site for determining whether the patient is experiencing a certain medical condition; and
means for generating an automated response when it is determined that the patient is experiencing the certain medical condition.

16. The system of claim 15, further comprising means for collecting additional information by querying the patient through the patient activator device to provide additional information related to the symptoms.

17. The system of claim 15, further comprising means for collecting additional information by monitoring at least one physiological signal associated with the patient and the symptoms and deriving a corresponding physiological parameter from each sensed physiological signal.

18. The system of claim 3, further comprising monitoring the at least one physiological signal in at least one of an implantable, subcutaneous and external medical device in contact with the patient.

19. The system of claim 15, wherein the means for generating an automated response includes a clinical decision program operating on a computing device at the diagnostic site for analyzing the collected information sent to the diagnostic site and for determining whether the patient is experiencing a certain medical condition.

20. The system of claim 18, wherein the automated response includes an alert signal from the diagnostic site upon the determination that the patient is experiencing a certain medical condition for providing a notification of the diagnosed medical condition to at least one of the patient, a physician, a designated responder, or an emergency response treatment individual.
